(19) United States
(12) Patent Application Publication
(10) Pub. No.: US 2008/0024830 A1
(43) Pub. Date: Jan. 31, 2008

(54) Internet protocol compliant scanner interface system

(75) Inventors: Daniel L. Lind, Fishers, IN (US); Matthew J. Meksschun, Indianapolis, IN (US); John R. Shutts, Avon, IN (US)

Correspondence Address: ICE MILLER LLP, ONE AMERICAN SQUARE, SUITE 3100, INDIANAPOLIS, IN, 46282-0200, US

(73) Assignee: AIDEA Incorporated, Indianapolis, IN (US)

(21) Appl. No.: 11/784,685

(22) Filed: Apr. 9, 2007

Related U.S. Application Data
(60) Provisional application No. 60/790,054, filed on Apr. 7, 2006.

(51) Int. Cl. G06F 13/38; H04N 1/00

(52) U.S. Cl. 358/401

(57) ABSTRACT

A BSMC for use with a scanner comprises a processor, a network port coupled to the processor, a scanner interface port coupled to the processor which receives data from the scanner interface port and transmits messages based on the received data to the network port. Scanning system are also disclosed with one or more scanners and one or more BSMCs communicating via a network with a web browser.

### RELATED APPLICATIONS

This application claims priority to co-pending US Provisional application Ser. No. 60/790,054 filed Apr. 7, 2006, the disclosure of which is expressly incorporated herein by this reference.

### BACKGROUND AND SUMMARY

The present disclosure relates to web enabled barcode symbology and/or match checkers (“BSMCs”) for utilization with a scanner and more particularly to a BSMC having a web server incorporated therein for controlling a scanner and allowing user input via a network from a web-enabled device.

In the fields of automated assembly, manufacturing, and packaging, it is well known to use scanners to identify objects as they move down an automated assembly line. For example, objects may have printed optical codes that may be read by optical scanners, radio frequency identification (RF-ID) tags that can be read by electromagnetic scanners, and the like. Especially in regards to packaging, there may be a need to use a scanner to identify objects as they move down the line. For example, a manufacturer of pre-printed cardboard boxes may need to verify that the universal product code (UPC) printed on each box is either readable, or that the code matches a the proper UPC code associated with the product that the box will eventually contain.

Currently, BSMCs exist that initiate a scanner to an operational mode, trigger the scanner to scan objects, and read codes returned by the scanner. These BSMCs may then compare that code to a match code, and perform some action if the match code does or does not equal the read code. Known BSMCs are generally set up manually. For example, an assembly line worker may take a known bar code, press a button on a control panel of the BSMC, and place the known bar code under the scanner in order to enter a match code into the BSMC. Additionally, known BSMCs may have some visual indicators, such as segmented L.E.D. displays, that show the number of matches, mismatches, and the like for the attached scanner.

It would be desirable to provide a BSMC that is able to automatically detect and configure an attached scanner. It would be further desirable to provide a BSMC that is capable of storing a match list that consists of a number of match codes, and compare each read value read by a scanner to every value in the match list to determine whether or not a match has occurred. Furthermore, it would be desirable to provide a BSMC that is configurable to operate in a master/slave configuration such that once the master BSMC has been configured into a certain mode, and with a certain match list, the slave controllers may read this configuration from the master controller. Additionally, it would be desirable to provide a BSMC that includes a network port and an integrated web server to allow for communication with a computer user at a remote location.

According to one aspect of the disclosure, a BSMC for use with a scanner for reading bar-code symbology includes a processor, a network port, and a scanner interface port. Both the network and scanner interface ports are communicatively coupled to the processor The processor receives data from the scanner interface port and transmits messages based on the received data to the network port. The processor runs a web server application including an automated object downloader for transporting a web component into a web browser of a user communicatively coupled to a network communicatively coupled to the network port.

According to another aspect of the disclosure, a scanning system comprises a network, a web browser, a scanner and a BSMC. The web browser is communicatively coupled to the network. The scanner is configured to read barcode symbology. The BSMC is communicatively coupled to and controls the scanner via a scanner interface port. The BSMC includes a processor and a network port communicatively coupled to the processor and the network. The processor receives data from the scanner via the scanner interface port and transmits messages based on the received data to the network port. The processor runs a web server application for communicating with the web browser via the network port.

According to yet another aspect of the disclosure, a scanning system comprises a network, a network browser, a first scanner, a first BSMC, a second scanner and a second BSMC. The network browser is coupled to the network. The first BSMC is communicatively coupled to and controls the first scanner via a first scanner interface port. The first BSMC further includes a first processor and a first network port coupled to the first processor. The first scanner is configured to operate in a master operational mode. The first processor receives data from the first scanner via the first scanner interface port and transmits messages based on the received data to the first network port. The second BSMC is communicatively coupled to and controls the second scanner via a second scanner interface port. The second BSMC further includes a second processor and a second network port coupled to the second processor and is configured to operate in a slave operational mode. The second processor receives data from the second scanner via the second scanner interface port, transmits messages based on the received data to the second network port and receives instructions from the first BSMC via the second network port.

The objects and advantages of the disclosed BSMC and networked scanning system will be more apparent upon reading the following detailed description in conjunction with the accompanying drawings.

### BRIEF DESCRIPTION OF THE DRAWINGS

The disclosed apparatus, method and user interface are illustrated by way of example and not limitation in the figures of the accompanying drawings in which like reference numerals indicate similar elements and in which:

FIG. 1 is a block diagram of an embodiment of an internet compliant scanning system including a web enabled BSMC with indicators and user interfaces;

FIG. 2 is a block diagram of the system of FIG. 1 showing internal processor and interface boards of the BSMC;

FIG. 3 is a block diagram of the system of FIG. 1 showing one embodiment of the components of the internal processor and interface boards of the BSMC;

FIG. 4 is a schematic diagram of the interface board of FIG. 3;

FIG. 5 is a flow diagram for the “power-on” initialization of the BSMC;

FIG. 6 is a flow diagram of an embodiment of a self-configuration algorithm for the BSMC;

FIG. 7 is a flow diagram of an embodiment of a single mode routine for the BSMC;

FIG. 8 is a flow diagram of an embodiment of a master mode routine for the BSMC;

FIG. 9 is a flow diagram of an embodiment of a slave mode routine for the BSMC;

FIG. 10 is a flow diagram of an embodiment of a routine to process user input for the BSMC;

FIG. 11 is a block diagram of a plurality of slave BSMCs coupled via a network to a master BSMC coupled via the network to a web browser enabled device;

FIG. 12 is a screen shot of a graphical user interface screen for a web browser generated by the BSMC;

FIG. 13 is a screen shot of a log-in screen of a graphical user interface for a web browser generated by the BSMC;

FIG. 14 is a screen shot of a welcome screen of a graphical user interface for a web browser generated by the BSMC;

FIG. 15 is a screen shot of a configuration screen of a graphical user interface for configuring the BSMC;

FIG. 16 is a screen shot of the basic reporting screen of a graphical user interface which shows basic reporting information in text boxes; and

FIG. 17 is a screen shot of a detail report screen of the graphical user interface.

### DETAILED DESCRIPTION OF THE PRESENTLY PREFERRED EMBODIMENT

For the purpose of promoting an understanding of the principles of the disclosure, reference will now be made to the embodiments illustrated in the drawings and specific language will be used to describe the same. It will nevertheless be understood that no limitation of the scope of the disclosure is thereby intended, such alterations and further modifications in the illustrated devices and such further applications of the principles of the disclosure as illustrated therein being contemplated as would normally occur to one skilled in the art to which the invention relates.

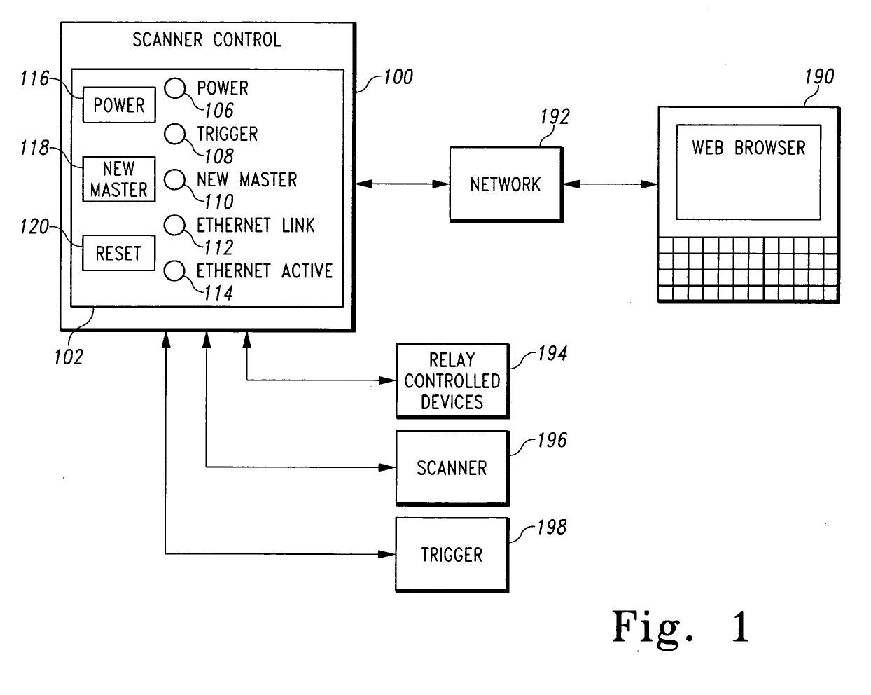

A first illustrative Barcode Symbology and/or Match Checker (“BSMC”) 100 is shown in FIG. 1 as a component of a scanning system 150. The scanning system 150 includes a scanner 196, a trigger 198, relay controlled devices 194, a BSMC 100 a network 192 and a web browser 190. The BSMC 100 may be coupled to the trigger 198, the scanner 196, and one or more relay controlled devices 194. Additionally, the BSMC 100 may be coupled to the web browser 190 via the network 192. The network 192 may support network protocols such as TCP/IP, IPX/SPX, NetBIOS, ATM, NetBEUI, AppleTalk, Token-Ring, and the like. It will be understood by those of skill in the art that the claimed invention may be implemented with virtually any network protocols. In one embodiment, the network 192 has a physical layer that is Ethernet and is capable of supporting TCP and IP protocols.

The web browser 190 may be a desktop computer system, such as an IBM personal computer or a compatible, an Apple Macintosh computer, a Sun Microsystems computer, an HP computer, or the like. In one embodiment the web browser 190 includes a windowing graphical user interface, such as X-Windows, Microsoft Windows, Darwin, or the like, running on Unix, Linux, HP-UX, Solaris, MS-DOS, Mac OS X, or the like. Additionally, the web browser 190 may be a web-enabled portable computing device, such as a wireless terminal (cell phone), or a palm-top computing device running the Palm OS or Windows CE operating systems. Additionally, the web browser 190 includes a web browser client software application. For example, the web browser software application may be Microsoft's Internet Explorer, Mozilla's Firefox, Opera's browser, Apple's Safari, or any other HTTP compliant web browser. It will be understood by those of skill in the art that the claimed invention may be used with virtually any HTTP compliant web browser irrespective of the hardware and operating system platform.

The trigger 198 may be a photoelectric sensor, a proximity sensor, a magnetic sensor, a camera, a weigh sensor, a radio frequency sensor, or any other type of sensor capable of detecting the presence of an object. The scanner 196 may be a barcode scanner, an RF-ID scanner, or some other type of scanner capable of scanning a tag, label, preprinted code, or a microchip from a distance and reading the symbology it contains. (For simplicity, the term “tag” is used herein to refer to an item containing symbols that can be read by a scanner.) In one embodiment, the scanner 196 is an MS-3CCD ultra-compact bar code scanner from Microscan Systems, Inc. In another embodiment, the scanner 196 is an MS-820 industrial bar code scanner, also from Microscan Systems, Inc. The relay controlled devices 196 may be a pick-and-place robotic device, an air blower, an indicator such as a light or sound generator, or the like.

In general operation, the scanner 196 may be located near an automated assembly line, such that the scanner 196 can read tags on objects traveling down the line in the proximity of the scanner 196. The trigger 198 is situated near the scanner 196 in order to detect the physical presence of objects as they pass down the line into the scanning range of the scanner 196. When the trigger 198 detects an object within the scanning range of the scanner, the trigger 198 sends a trigger signal to the BSMC 100.

Upon receiving the trigger signal, the BSMC 100 illuminates the trigger indicator 108 on the control panel or keypad 102, and sends a trigger signal to the scanner 196. Upon receiving the trigger signal, the scanner 196, scans the tag on the object and sends any detected symbols to the BSMC 100. In the event that the scanner 196 is not able to read any symbols or reads an incomplete set of symbols (“bad read”), or the symbols read are not as expected (“mismatch”), the BSMC 100 may send a signal to one of the relay controlled devices 194.

For example, in an automated assembly line it may be desirable to remove the object from the assembly line in the case of a bad read or a mismatch, and this removal may be carried out by one of the relay controlled devices 194. Illustratively, in the production of boxes of dried pasta, a bad read may indicate that a pasta box is not properly oriented or does not have a tag, while a mismatch may indicate that box is for another type of pasta than the pasta currently being packaged. Detecting one mismatching box may cause the BSMC 100 to activate a first relay controlled devices 194 that removes the box from the line, while detecting ten mismatching boxes may cause the BSMC 100 to activate a second relay controlled devices 194 that stops the line and/or sounds an alarm.

The BSMC 100 includes a memory that stores one or more master symbol sets, or master codes. For example, a master code may be universal product codes (UPCs), inventory numbers, names, item numbers, part numbers, serial numbers, or the like. The user may set a new master code by placing a tag including the desired master code within scanning range of the scanner 196, and pressing the new master key 118. Upon a successful read of the new master code, the new master indicator 110 will illuminate. Thereafter, as tags are scanned by the scanner 196, the BSMC 100 will compare the scanned codes to the master code, and take appropriate actions based on whether the scanned codes matches the master code. Additionally, the BSMC 100 will update stored values for whether a read was complete or incomplete (“good read” and “bad read” values), and for good reads whether or not the read code matches the master code (“match” and “mismatch” values).

In one embodiment, the user enters one or more master codes into the BSMC 100 by way of the web browser 190. Such a list of master codes is referred to herein as a “watch list” or a “match list.” For example, the user may enter eight match list codes via the web browser 190 for storage in the match list of the BSMC 100. In this case, the BSMC 100 will count any scanned item which matches one of the match list codes as a “match.” Similarly, any scanned item that that does not match one of the match list codes will be considered to be a “mismatch.”

Illustratively, as items pass down an assembly line and are scanned, the BSMC 100 will continuously update four stored values: good reads; bad reads; matches; and, mismatches. These stored values will be dynamically updated on a web server maintained internally to the BSMC 100. By this method, the user may obtain the status of the scanning process via the web browser 190, which may be in an office far away from the assembly line, in another city or state, or even aboard a moving vehicle. The operation of the BSMC 100, and its internal components are described below in more detail.

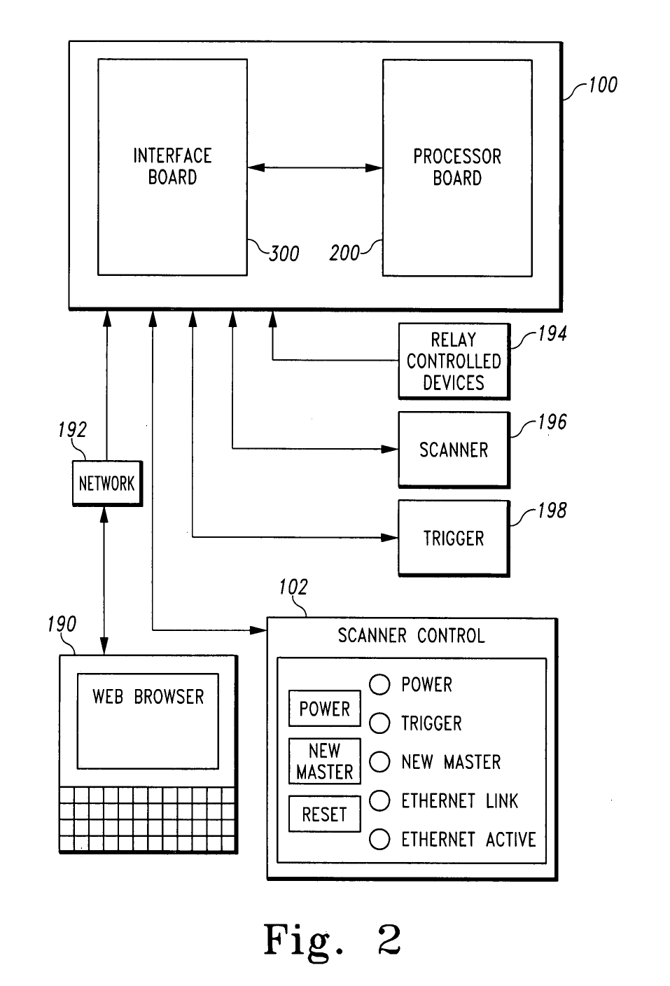

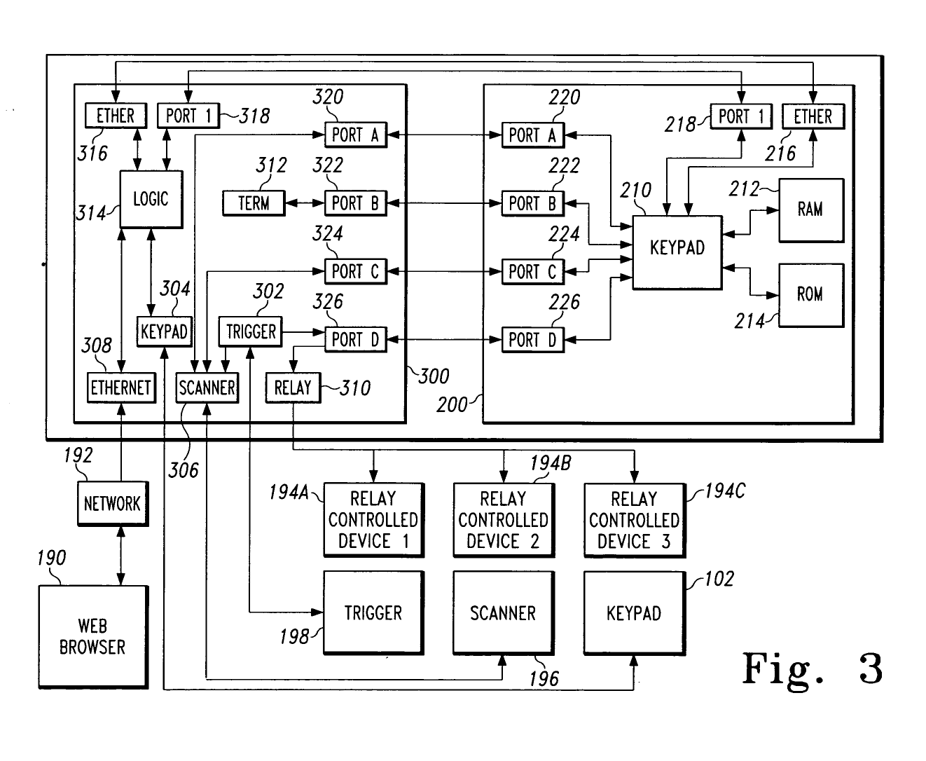

Turning to FIG. 2, the BSMC 100 includes an interface board 300, and a processor board 200. The processor board 200 may include a processor, input and output ports, and memory, as described in more detail in FIG. 3. The interface board 300 may include various interface circuitry to allow the processor board 200 to communicate with the relay controlled devices 194, the scanner 196, the trigger 198, the keypad 102, the network 192, and the web browser 190. The BSMC 100 may also include a switching power supply and a back-up power supply, which are not shown in FIG. 2, the implementation of which will be well understood by those of skill in the art.

Turning to FIG. 3, the processor board 200 and the interface board 300 are shown in greater detail. The processor board 200 may include a processor 210, a RAM memory 212, a ROM memory 214, and a series of ports. The processor 210 may be an Intel '386, '486, or Pentium microprocessor, a Motorola 68000 series processor, an IBM processor, or a microcontroller. The RAM 212 may be any type of dynamic memory capable of storing and retrieving data, including a Flash or EEPROM memory. The ROM 214 may be any type of persistent memory capable of storing data without power. For example, the ROM 214 may be a 512K flash memory. The processor board 200 may also include a port A 220, a port B 222, a port C 224, a port D 226, a port 1 218, and an Ethernet port 216. In one embodiment, port A 220 and port B 222 are RS-232 compatible Serial ports. Port C 224 and port D 226 may be digital I/O ports configurable as serial and/or parallel inputs or outputs, interrupts, and the like, that are capable of sourcing or sinking a current. Similarly, port 1 218 may be an configurable as outputs or inputs capable of sourcing or sinking a current, respectively. The Ethernet port 216 may be an 10 BASE-T or NE2000 compatible Ethernet port, and may have a link status and an activity status. In one preferred embodiment, the processor board 200 is a LogicFlex Single Board Computer produced by JK Microsystems, Inc.

The interface board 300 includes a port A jumper 320, a port B jumper 322, a port C jumper 324, and a port D jumper 326. These jumpers allow for communication between the circuitry of the interface board 300 and the processor 210, via the ports or the processor board 200. Additionally, the interface board 300 includes an Ethernet port jumper 316, and a port 1 jumper 318. The Ethernet jumper 316 and the port 1 jumper 318 allow the interface board 300 to communicate with the processor 210, via port 1 218 and Ethernet port 216 on the processor board 200.

The interface board 300 may additionally include an Ethernet port 308, a keypad port 304, a scanner port 306, a trigger port 302, and a relay port 310. The Ethernet port 308 provides for communication between the network 192 and the processor 210 via the Ethernet jumper 316 and the Ethernet port 216. The keypad port 304 may provide for communication between the keypad 102, and the Interface Logic 314, which in turn allows for the processor 210 to read the status of the power switch 116, the new master switch 118, and the reset switch 120. Additionally, the keypad 102 allows for the processor 210 to control the power indicator 106, the trigger indicator 108, the new master indicator 110, the Ethernet link indicator 112, and the Ethernet active indicator 114.

The trigger port 302 allows the BSMC 100 to receive a trigger signal from the trigger 198. The trigger port 302 is also coupled the scanner port 306 in order to provide the trigger signal from the trigger 198 to the scanner 196. Additionally, the trigger port 302 is coupled to the port D jumper 326 in order to communicate the trigger signal to the processor 210 via the port D 226. The scanner port 306 is coupled to the scanner 196. Additionally, the scanner port 306 is coupled to the trigger port 302, the port C jumper 324, and the port A jumper 320. The scanner port 306 allows for bi-directional communication between the processor 210 and the scanner 196. For example, configuration information may be sent to the scanner 196 by the processor 210 via the scanner port 306. Additionally, symbols read by the scanner 196, as well as the scanner's self-identification information, may be sent from the scanner 196 to the processor 210 via the scanner port 306.

The relay port 310 receives relay information via port D jumper 326 from the processor 210. The relay port 310 may include relays that are configured as “normally-opened” or “normally-closed. ” Illustratively, the relay port 310 may provide switched outputs to relay controlled devices 194A, relay controlled device 194B, and relay controlled device 194C. Each of the relay controlled devices 194 may be configured such that when the relay state changes from open to closed, or from closed to open, the device performs some action. In this manner, the processor 210 may activate the relay controlled devices 194 in response to certain events.

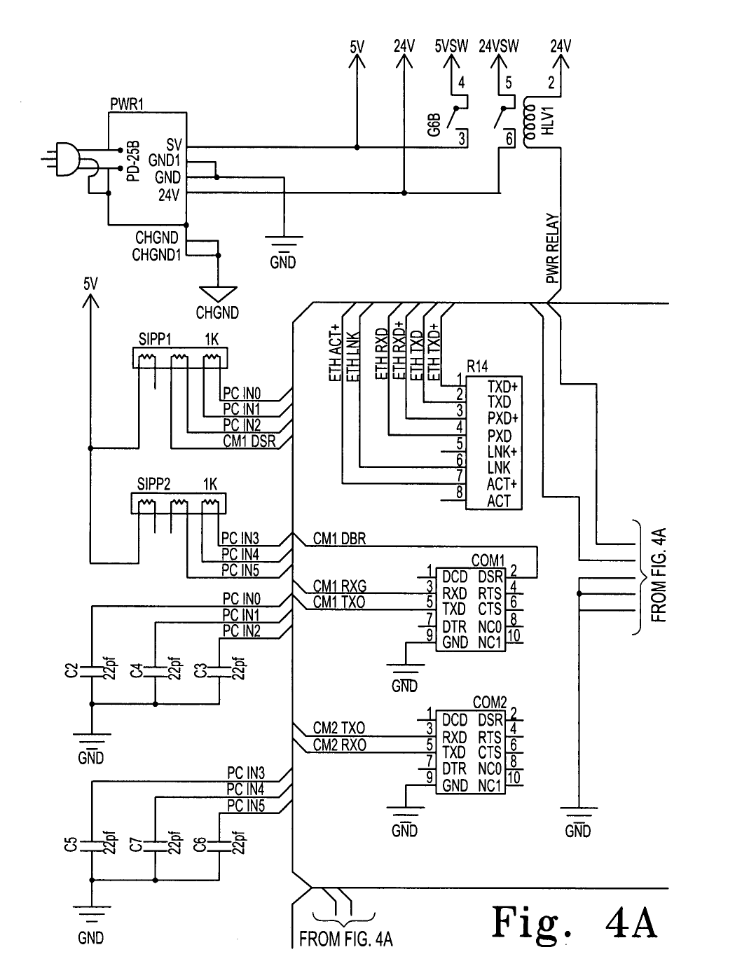

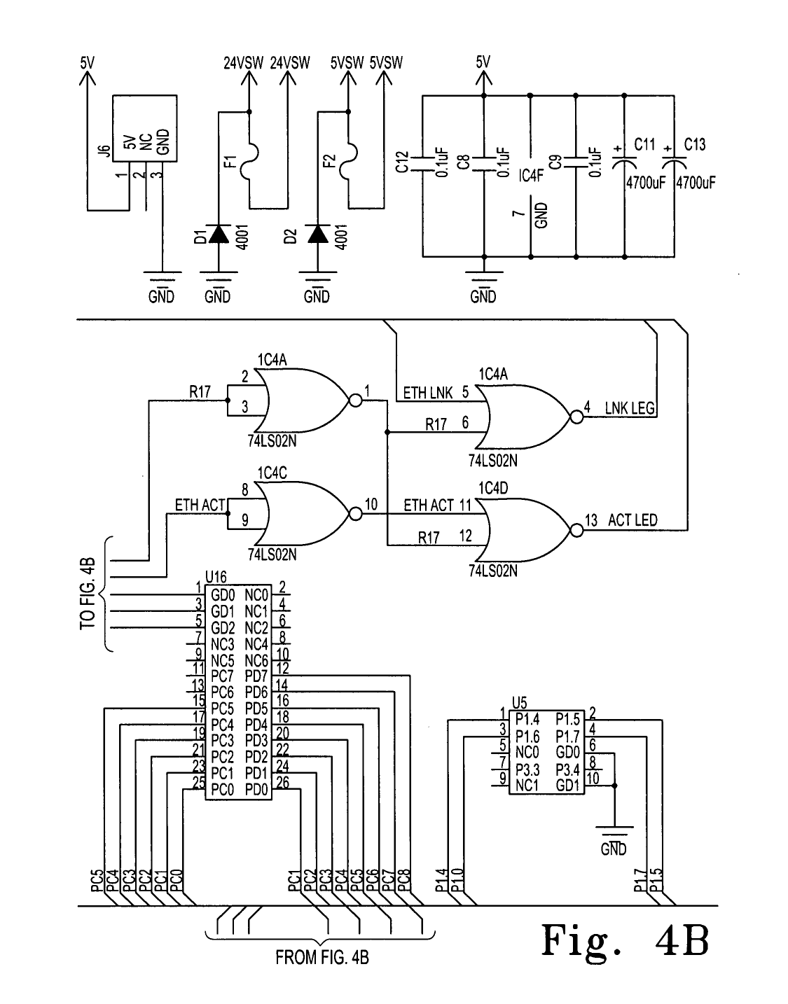

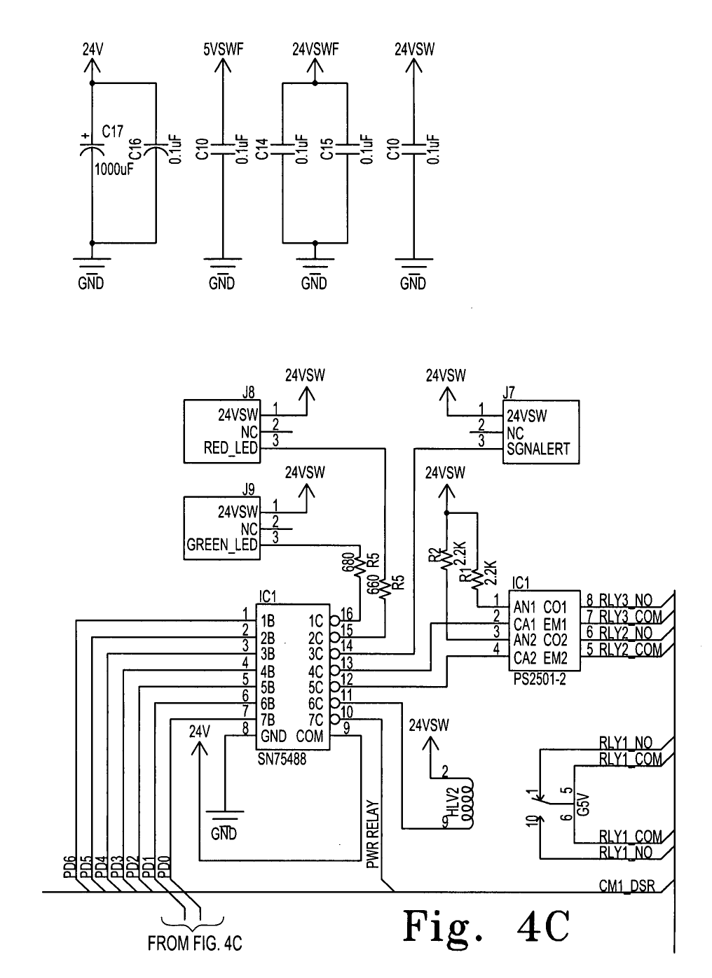

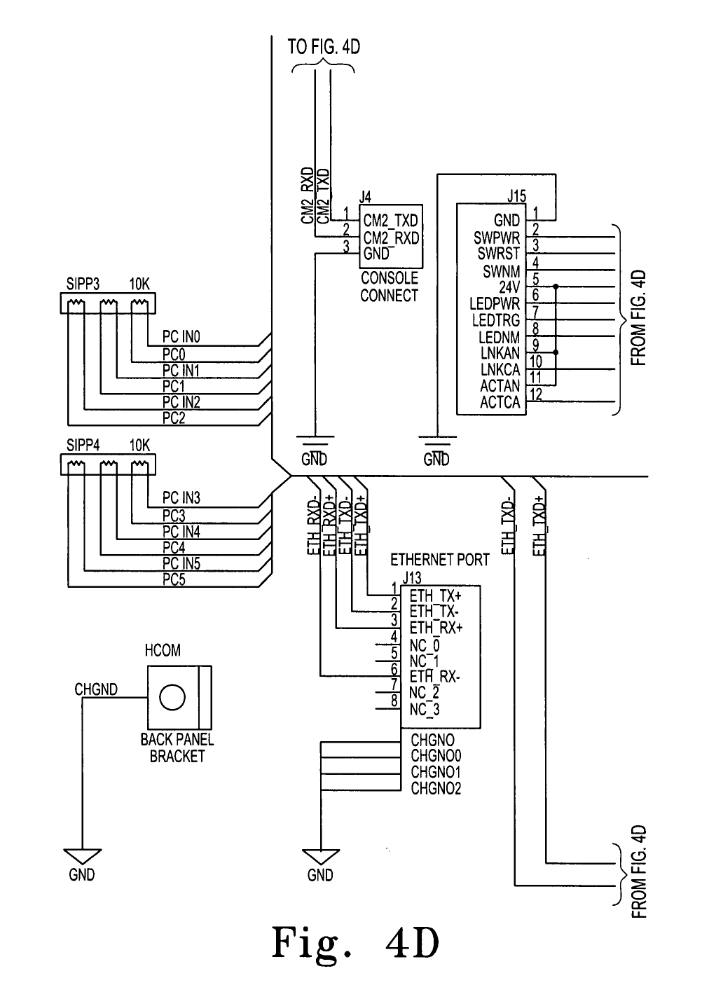

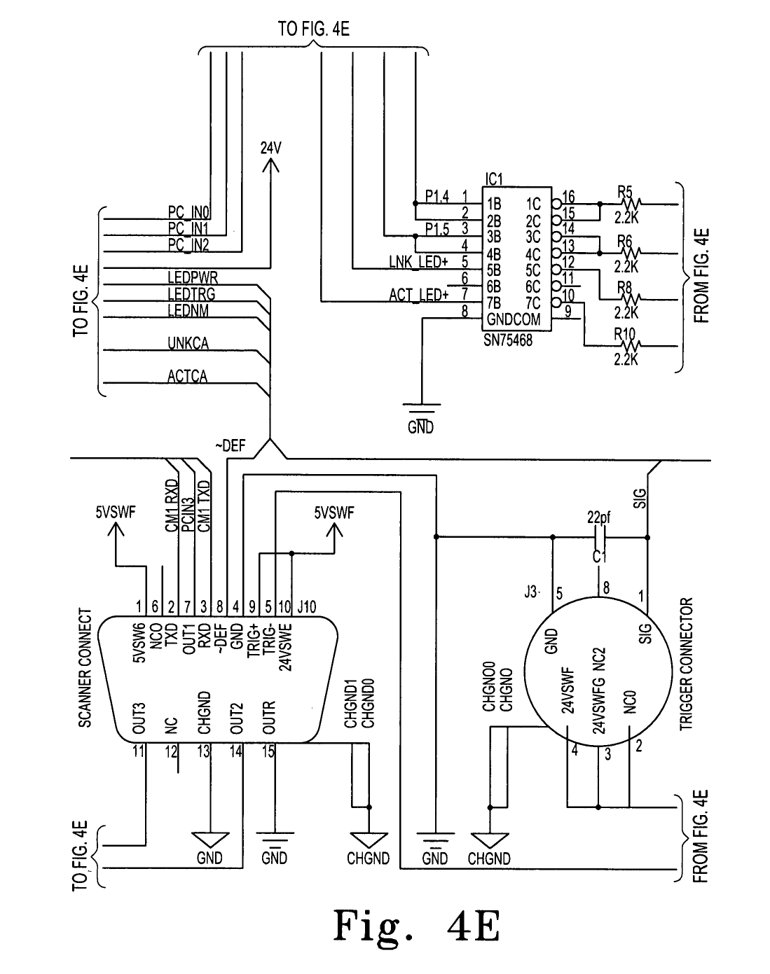

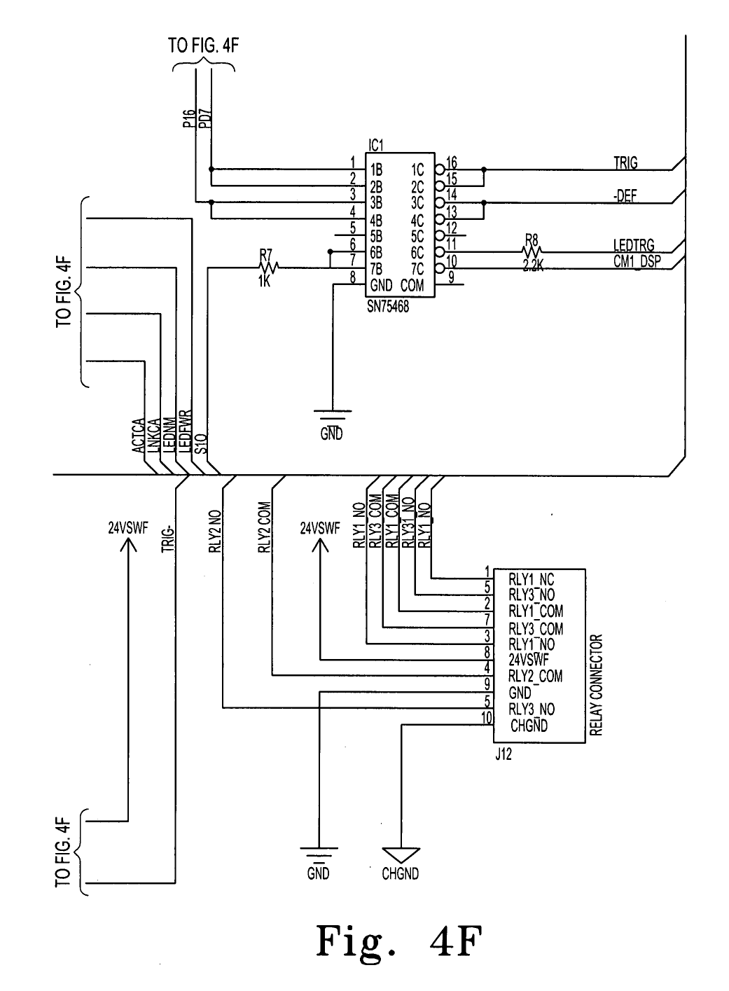

FIG. 4 is a schematic diagram of one embodiment of the interface board 300. Those of skill in the art of embedded computer and controller design will understand how the interface board 300 interfaces between the processor board 200, the network 192, the trigger 198, the scanner 196, the keypad 102, and the relay controlled devices 194.

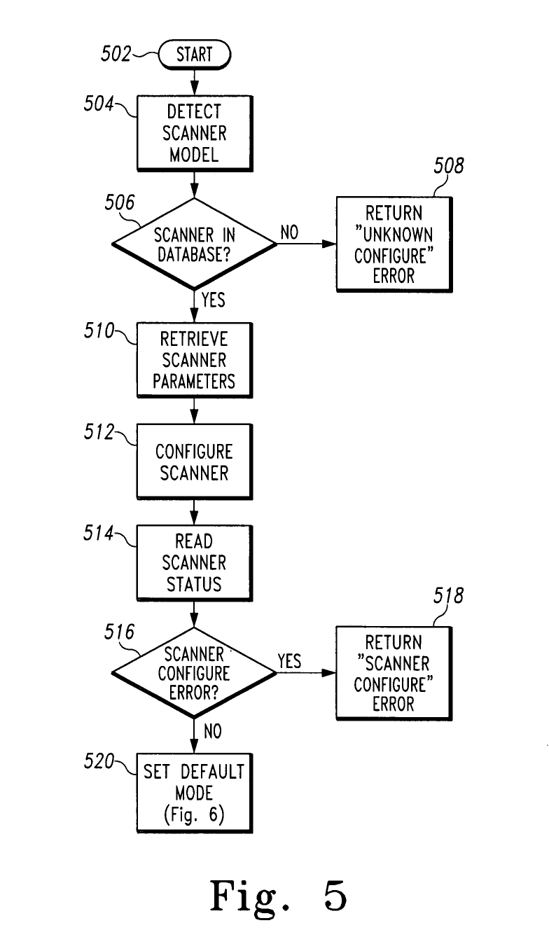

Turning to FIG. 5, a flowchart for the “power-on” initialization of the BSMC 100 is shown. At step 502, the BSMC 100 first receives power. At step 504, the BSMC 100 sends an identification request to the scanner 196 via the scanner port 306. Upon receiving the identification request, the scanner 196 responds to the BSMC 100 with an identification code. The BSMC 100 determines at step 506 whether the identification code is included in its internal scanner configuration database. For example, the BSMC 100 may maintain an XML document as a database that includes configuration information for a variety of scanners, keyed by identification code. This database may be updated from time to time by the user via communications over the network 192.

If the scanner identification code is not included in the internal scanner configuration database, at step 508 the BSMC 100 may return an “unknown scanner” error to the user. If, however, the identification code is in the internal scanner database, then at step 510 the BSMC 100 may retrieve configuration parameters for the scanner 196. At step 512, the BSMC 100 may send the retrieved scanner configuration parameters to the scanner 196. At step 514, the BSMC 100 may read the configuration status of the scanner 196. At step 516, the BSMC 100 may determine whether there was an error during the configuration of the scanner 196 based on the scanner configuration status. If there was an error, then at step 518 the BSMC 100 may return a “scanner configuration” error message to the user. However, if there was no error in the scanner configuration, then at step 520 the BSMC 100 may set itself to its default mode, according to the flowchart in FIG. 6.

Turning to FIG. 6, one illustrative embodiment of a self-configuration algorithm for the BSMC 100 is shown. Those of skill in the art will understand that a different self-configuration algorithm may be appropriate, for example, when the BSMC 100 includes more or fewer operational modes and read modes. The illustrative embodiment of the self-configuration algorithm in FIG. 6 is for example only, and is not intended to limit the claimed invention in any way.

At step 602 the BSMC 100 enters the configuration mode. At step 604, the BSMC 100 reads any parameters sent by the calling routine. For example, some of the parameters that may be passed are whether the scanner is a master or slave, a match list, and the like. At step 606, the BSMC 100 determines whether the calling parameters include a master, slave, or single mode command. If so, then at step 608 the BSMC 100 determines whether the command is a single mode command. If so, then at step 614, the BSMC 100 sets its operational mode to single. If not, however, at step 610 the BSMC 100 determines whether the calling parameters include a master mode command. If not, then at step 616 the BSMC 100 sets the operational mode to slave mode. On the other hand, if the calling parameters include a master mode command, then at step 612 the BSMC 100 sets the mode to master mode.

After the BSMC sets the operational mode at 612, 614, or 616, then at step 618 the BSMC 100 may determine whether a match list, or a portion of a match list, was included in the calling parameters. If so, then at step 620 the BSMC 100 sets or updates the match list. If not, then at step 622 the BSMC 100 determines whether the calling parameters include a command to set the read mode to “good/bad.” If so, then at step 624 the BSMC 100 sets its read mode to “good/bad” mode. If not, then at step 626 the BSMC 100 sets its read mode to “match.”

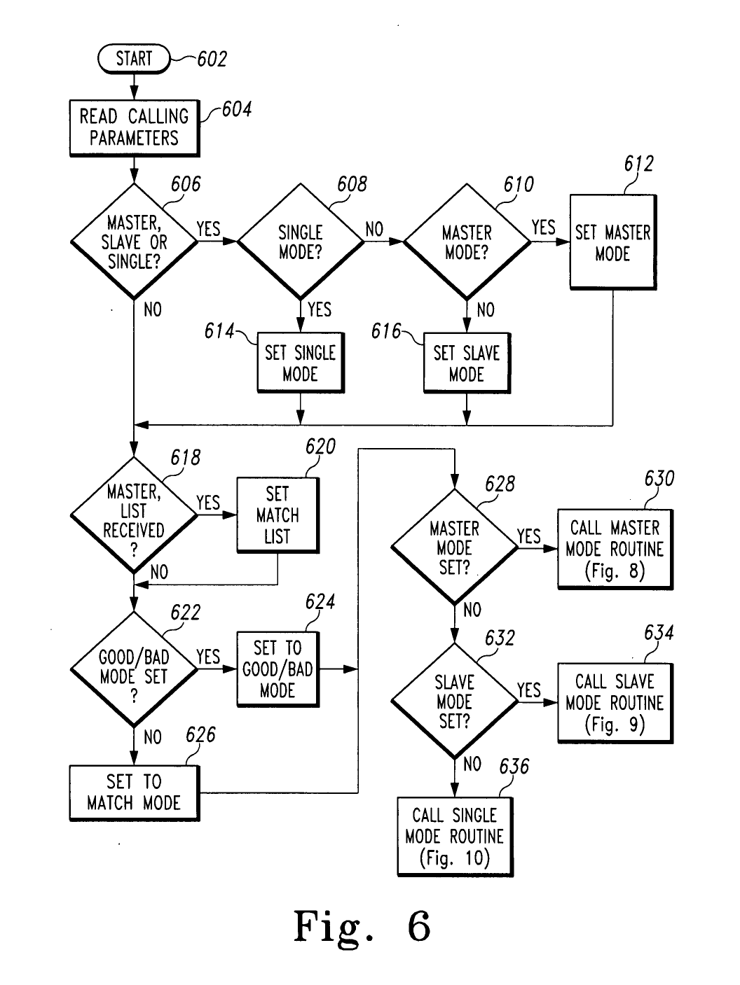

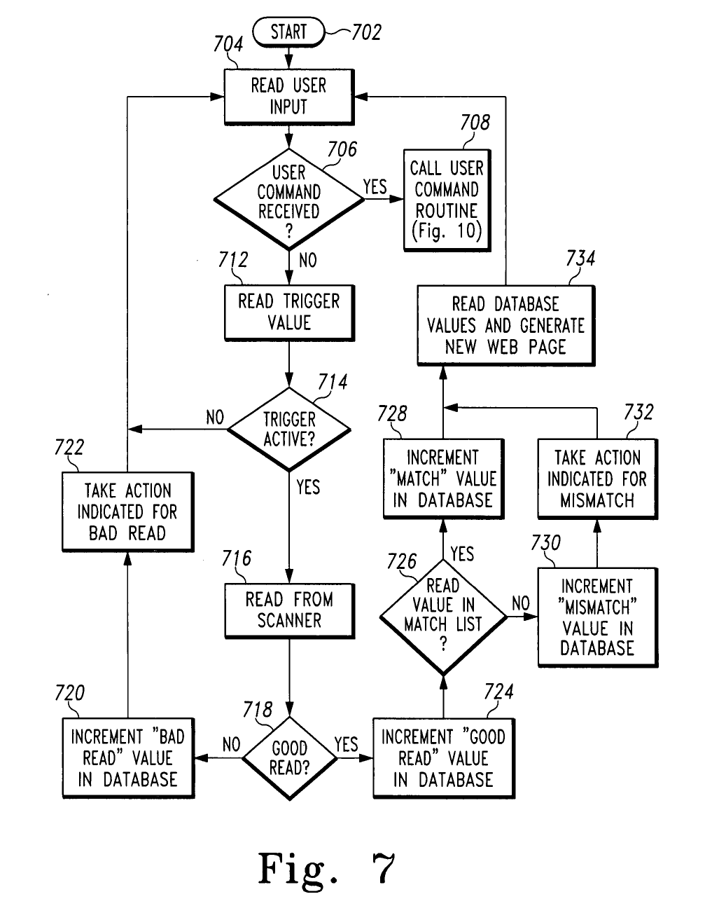

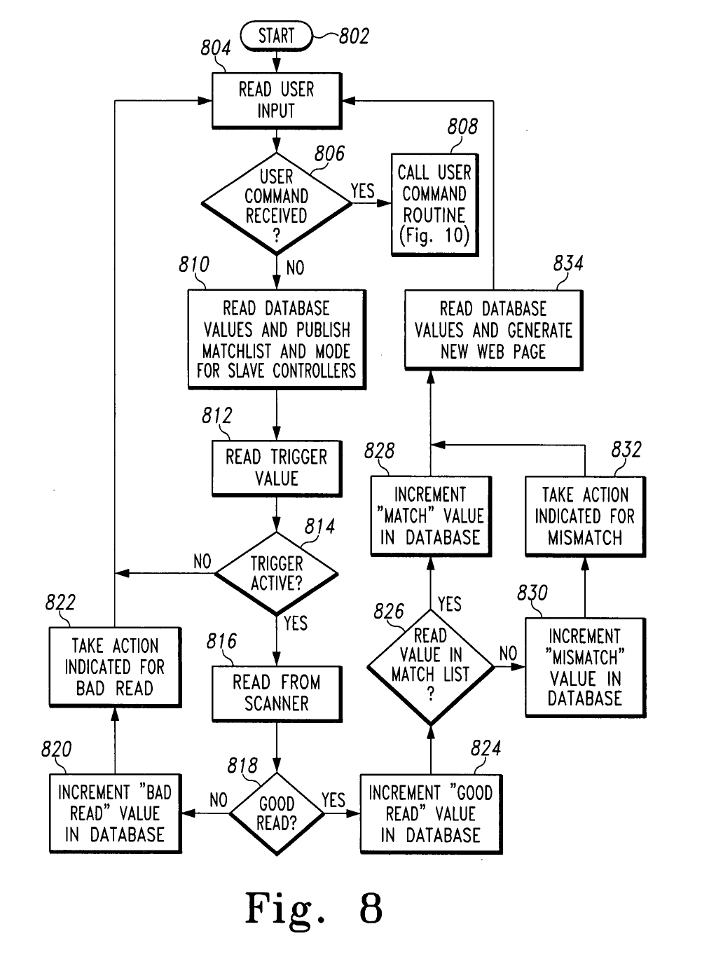

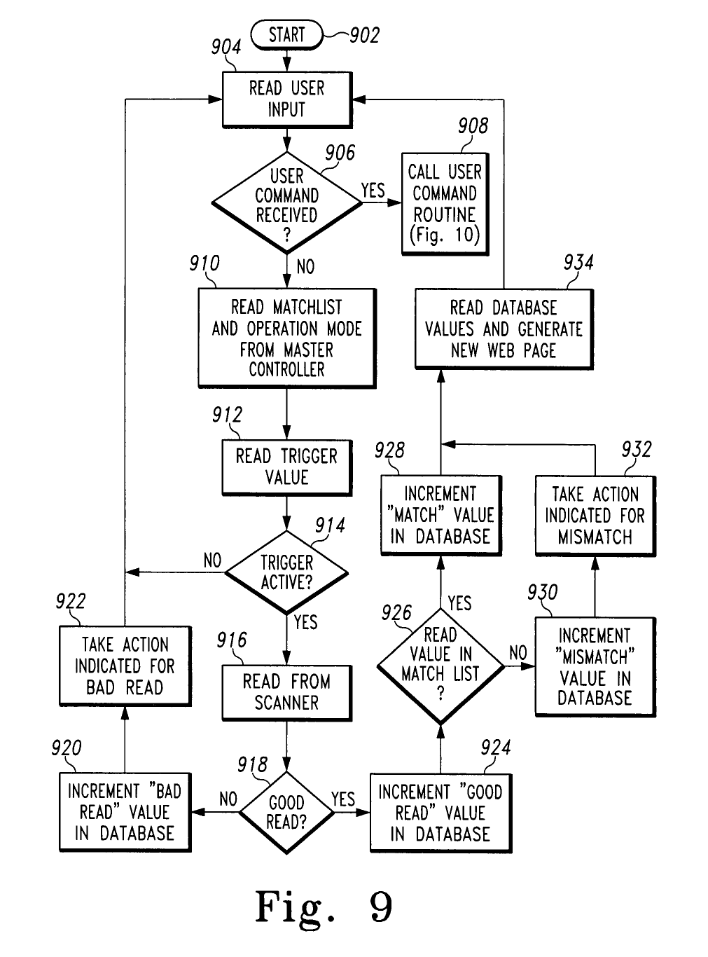

After the read mode is set at step 624 or step 626, then at step 628 the BSMC 100 determines whether the current operational mode is master mode. If so, then at step 630 the BSMC 100 enters the master mode routine shown in FIG. 8. If at step 628 the BSMC determined it is not in master mode, then at step 632 the BSMC 100 determines whether the operational mode is set to slave mode. If so, then at step 634 the BSMC 100 enters in to the slave mode routine, shown in FIG. 9. If not, then at step 636 the BSMC 100 enters in to the single mode routine, shown in FIG. 10.

Turning to FIG. 7, one illustrative embodiment of a single mode routine for the BSMC 100 is shown. Those of skill in the art will understand that a different single mode routine may be appropriate, for example, when the BSMC 100 includes more or fewer read modes or features. The illustrative embodiment algorithm in FIG. 7 is for example only, and is not intended to limit the claimed invention in any way.

At step 702, the BSMC 100 enters the single mode of operation. In this mode, the BSMC 100 works independently of other BSMCs 100. (In other words, the BSMC 100 is not part of a master-slave configuration.) At step 704, the BSMC 100 reads any available user input from either the keypad 102, or user input received via the Ethernet port 308 from the web browser 190. At step 706, the BSMC 100 determines whether any user commands have been received. If so, then at step 708 the BSMC 100 calls the user command routine, shown in FIG. 10.

If no user commands have been received, then at step 712 the BSMC 100 reads the status of the trigger port 302. For example, a “high” signal may indicate a trigger (active state), while a “low” value may indicate no trigger (inactive state). At step 714, the BSMC 100 determines whether the trigger 198 is currently active. If the trigger 198 is not active, then the BSMC 100 returns to step 704 to process user input. If the trigger 198 is active, then at step 716 the BSMC 100 instructs the scanner 196 to conduct a scanning operation, via the scanner port 306, and reads the resultant data from the scanner 196.

At step 718, the BSMC 100 determines whether the scanner 196 completed a “good read,” or whether there was “bad read,” indicating no or erroneous data. If the BSMC 100 determines that there was a bad read, then at step 720 the BSMC 100 increments the “bad read” value in its internal database, and at step 722 the BSMC 100 may take an action based on the bad read. For example, the BSMC 100 may activate one of the relay controlled devices 194, which may, for example, remove an object that was the source of the bad read from an automated assembly line. After taking any actions at 722, the BSMC 100 returns to step 704 to read any user input.

On the other hand, if at step 718 the BSMC 100 determined that there was a good read, then at step 724 the BSMC 100 increments the “good read” value in its internal database. Next, the BSMC 100 compares the read value from the scanner 196 to any value(s) in its match list 726. If there are multiple values in the match list, then the BSMC 100 compares the read value to each value in the match list 726. If the read value matches one of the values in the match list, then at step 728 the BSMC 100 increments a “match” value in its internal database. However, if the read value does not match one of the values in the match list, then at step 730 the BSMC 100 increments the “mismatch” value in its internal database. (Note that in the “good/bad” operational mode, the match and mismatch values are ignored.)

Next, the BSMC 100 may take an action at step 732 by activating one of the relay controlled devices 194. After completing steps 728 or 732, the BSMC 100 reads the values in its internal database (i.e. bad read value, good read value, match value, mismatch value) and generates a new dynamic web page based on the values from the database.

Alternatively, in an embodiment where the web browser loads an object from the BSMC 100, such as a Java applet, Java script, Macromedia Flash object, or the like, the BSMC 100 may merely update the served values for retrieval by the object. After updating the values or the web page, the BSMC 100 returns to step 704 to process any additional user input.

Turning to FIG. 8, one illustrative embodiment of a master mode routine for the BSMC 100 is shown. Those of skill in the art will understand that a different master mode routine may be appropriate, for example, when the BSMC 100 includes more or fewer modes or features. The illustrative embodiment of a master mode routine in FIG. 8 is for example only, and is not intended to limit the claimed invention in any way.

At step 802, the BSMC 100 enters the master mode of operation. In this mode, the BSMC 100 works in conjunction with slave BSMCs 100 as part of a master-slave configuration. At step 804, the BSMC 100 reads any available user input from either the keypad 102, or user input received via the Ethernet port 308 from the web browser 190. At step 806, the BSMC 100 determines whether any user commands have been received. If so, then at step 808 the BSMC 100 calls the user command routine, shown in FIG. 10.

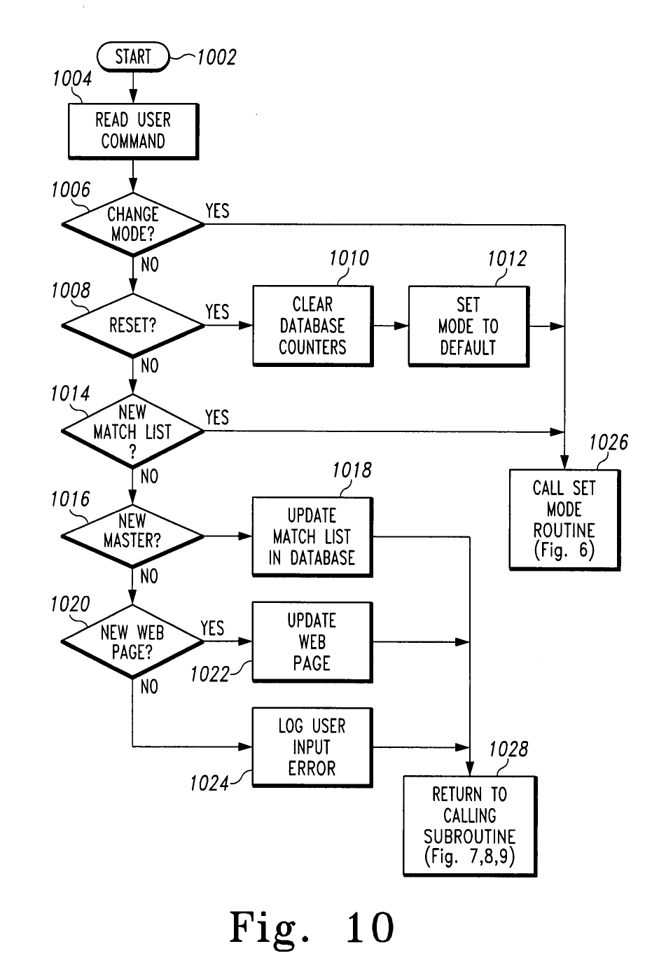

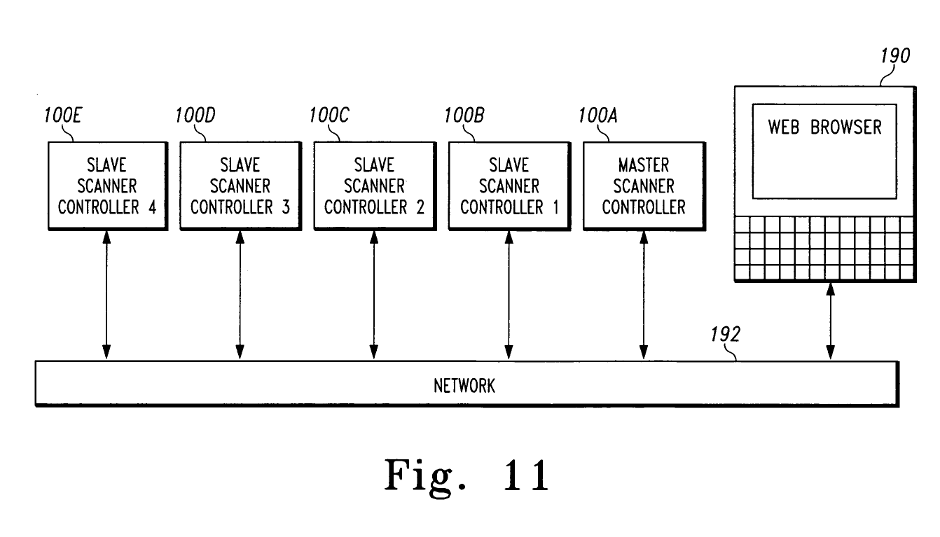

At step 810, the BSMC 100 reads internal database values to determine the match list and the operational mode in which it is currently operating. The BSMC 100 publishes the match list and/or the operational mode so that these values may be read by slave BSMCs in a master-slave configuration. One illustrative embodiment of a master-slave configuration is shown in FIG. 11. As shown in FIG. 11, the web browser 190 and the master controller 100A communicate via the network 192. The web browser 190 allows a user to configure the master controller 100A with a watch list and an operational mode. Because the user has configured the BSMC 100A as the master BSMC, the BSMC 100A executes the master mode routine in FIG. 8. As noted, at step 810, the BSMC 100 publishes the match list and/or the operational mode for the slave BSMCs 100B-100E to read. In this manner, the operator may configure a multitude of BSMCs 100 without having to set the parameters (match list, operational mode, and the like) for every BSMC 100 individually.

Returning to FIG. 8, at step 812 the BSMC 100 reads the status of the trigger port 302. For example, a “high” signal may indicate a trigger (active state), while a “low” value may indicate no trigger (inactive state). At step 814, the BSMC 100 determines whether the trigger 198 is currently active. If the trigger 198 is not active, then the BSMC 100 returns to step 804 to process user input. If the trigger 198 is active, then at step 816 the BSMC 100 instructs the scanner 196 to conduct a scanning operation, via the scanner port 306, and reads the resultant data from the scanner 196.

At step 818, the BSMC 100 determines whether the scanner 196 completed a “good read,” or whether there was “bad read,” indicating no or erroneous data. If the BSMC 100 determines that there was a bad read, then at step 820 the BSMC 100 increments the “bad read” value in its internal database, and at step 822 the BSMC 100 may take an action based on the bad read. For example, the BSMC 100 may activate one of the relay controlled devices 194, which may, for example, remove an object that was the source of the bad read from an automated assembly line. After taking any actions at 822, the BSMC 100 returns to step 804 to read any user input.

On the other hand, if at step 818 the BSMC 100 determined that there was a good read, then at step 824 the BSMC 100 increments the “good read” value in its internal database. Next, the BSMC 100 compares the read value from the scanner 196 to any value(s) in its match list. If there are multiple values in the match list, then the BSMC 100 compares the read value to each value in the match list. If the read value matches one of the values in the match list, then at step 828 the BSMC 100 increments a “match” value in its internal database. However, if the read value does not match one of the values in the match list, then at step 830 the BSMC 100 increments the “mismatch” value in its internal database. (Note that in the “good/bad” operational mode, the match and mismatch values are ignored.)

Next, the BSMC 100 may take an action at step 832 by activating one of the relay controlled devices 194. After completing steps 828 or 832, the BSMC 100 reads the values in its internal database (i.e. bad read value, good read value, match value, value) and generates a new dynamic web page based on the values from the database. Alternatively, in an embodiment where the web browser loads an object from the BSMC 100, such as a Java applet, Java script, Macromedia Flash object, or the like, the BSMC 100 may merely update the served values for retrieval by the object. After updating the values or the web page, the BSMC 100 returns to step 804 to process any additional user input.

Turning to FIG. 9, one illustrative embodiment of a slave mode routine for the BSMC 100 is shown. Those of skill in the art will understand that a different slave mode routine may be appropriate, for example, when the BSMC 100 includes more or fewer modes or features. The illustrative embodiment of a slave mode routine in FIG. 8 is for example only, and is not intended to limit the claimed invention in any way.

At Step 904, the BSMC 100 reads any user input received via the key pad 102 or the network 192. In this mode, the BSMC 100 works in conjunction with a master BSMC 100 as part of a master-slave configuration. At step 904, the BSMC 100 reads any available user input from either the keypad 102, or user input received via the Ethernet port 308 from the web browser 190. At step 906, the BSMC 100 determines whether any user commands have been received. If so, then at step 908 the BSMC 100 calls the user command routine, shown in FIG. 10.

At step 910, the BSMC 100 reads a match list and an operational mode from a master controller. As shown in the exemplary a master/slave configuration of FIG. 11, the slave BSMC 100B operating as a slave controller may communicate via the network 192 with the master BSMC 100A. In operation, the user sets the operation mode and match list values in the master controller 100A via the web browser 190. At Step 910, the slave BSMC 100B reads these values from the master BSMC 100B, thereby alleviating the need for the user to separately set these values for the slave BSMC 100B.

Returning to FIG. 9, at step 912 the BSMC 100 reads the status of the trigger port 302. For example, a “high” signal may indicate a trigger (active state), while a “low” value may indicate no trigger (inactive state). At step 914, the BSMC 100 determines whether the trigger 198 is currently active. If the trigger 198 is not active, then the BSMC 100 returns to step 904 to process user input. If the trigger 198 is active, then at step 916 the BSMC 100 instructs the scanner 196 to conduct a scanning operation, via the scanner port 306, and reads the resultant data from the scanner 196.

At step 918, the BSMC 100 determines whether the scanner 196 completed a “good read,” or whether there was “bad read,” indicating no or erroneous data. If the BSMC 100 determines that there was a bad read, then at step 920 the BSMC 100 increments the “bad read” value in its internal database, and at step 922 the BSMC 100 may take an action based on the bad read. For example, the BSMC 100 may activate one of the relay controlled devices 194, which may, for example, remove an object that was the source of the bad read from an automated assembly line. After taking any actions at 922, the BSMC 100 returns to step 904 to read any user input.

On the other hand, if at step 918 the B SMC 100 determined that there was a good read, then at step 924 the BSMC 100 increments the “good read” value in its internal database. Next, the BSMC 100 compares the read value from the scanner 196 to any value(s) in its match list. If there are multiple values in the match list, then the BSMC 100 compares the read value to each value in the match list. If the read value matches one of the values in the match list, then at step 928 the BSMC 100 increments a “match” value in its internal database. However, if the read value does not match one of the values in the match list, then at step 930 the BSMC 100 increments the “mismatch” value in its internal database. (Note that in the “good/bad” operational mode, the match and mismatch values are ignored.)

Next, the BSMC 100 may take an action at step 932 by activating one of the relay controlled devices 194. After completing steps 928 or 932, the BSMC 100 reads the values in its internal database (i.e. bad read value, good read value, match value, mismatch value) and generates a new dynamic web page based on the values from the database. Alternatively, in an embodiment where the web browser loads an object from the BSMC 100, such as a Java applet, Java script, Macromedia Flash object, or the like, the BSMC 100 may merely update the served values for retrieval by the object. After updating the values or the web page, the BSMC 100 returns to step 904 to process any additional user input.

Turning to FIG. 10, one illustrative embodiment of a routine to process user input for the BSMC 100 is shown. Those of skill in the art will understand that a different routines may be appropriate, for example, when the BSMC 100 includes more or fewer modes or features. The illustrative embodiment of a routine to process user input in FIG. 10 is for example only, and is not intended to limit the claimed invention in any way.

This routine to process user input is called by other routines whenever the BSMC 100 detects that it has received user input either from the keypad 102 or the network 192. At step 1002, the BSMC 100 enters the user input processing mode. At step 1004, the BSMC 100 reads the received user command. At step 1006, the BSMC 100 determines whether the user command is a change mode command. If so, then the BSMC 100 proceeds to the set mode routine, shown in FIG. 6.

If the command was not a change mode command, then at step 1008 the BSMC 100 determines whether the command was the activation of the reset key 120 of the keypad 102. If so, then at step 1010 the BSMC 100 clears the database counters, and/or at step 1012 sets the operational mode to the default mode. Next, the BSMC 100 proceeds to step 1026 where it calls the set mode routine.

If at step 1008 the BSMC 100 determined that the user input was not a reset command, then at step 1014 the BSMC 100 determines whether the user input was a new match list received via the network 192. If the input was a new match list, then at step 1026 the BSMC enters the set mode routine, shown in FIG. 6. If the input was not a new match list, then at step 1016 the BSMC 100 determines whether the user command was an activation of the new master key 118. If so, then at step 1018 the BSMC 100 updates the match list in its internal database to include the contemporaneously read code received from the scanner 196. In one embodiment, the match list is cleared before the contemporaneously read code is added. In another embodiment, contemporaneously read code is added to the match list as an additional value.

If the BSMC 100 determined that the input was not the activation of the new master key 1016, then at step 1020 the BSMC 100 determines whether the user command was a request for a different web page. For example, the BSMC 100 may provide a variety of web pages to the user, showing statistics by the hour, by the day, or the like. If the request was for a new web page, then at step 1022 the BSMC 100 updates its internally produced dynamic web page. In some embodiments, the “web page” is an object, such as an applet, that is downloaded from the BSMC 100 to the web browser 190. In these embodiments, there may be no need to request a new “page,” because the object generates “pages” in the browser, and only the status values read by the object need ever be updated. In such embodiments, steps 1016 and 1018 may not be necessary.

If the BSMC 100 determines at step 1020 that the user command was not a request for a new web page, or that the command was not recognized, then the command may contain an error. Therefore, at step 1024 the BSMC 100 may generate a user input error message and send the error message to the user (via the web browser), or log the message in an internal log. After executing steps 1018, 1022, or 1024, the BSMC 100 returns to the calling subroutine, which will be one of the routines shown in FIGS. 7-9.

Turning to FIG. 11, one illustrative embodiment of a master BSMC 100A and 4 slave BSMCs 100B-100E are shown. In this illustrative embodiment, a single master BSMC 100A publishes a match list and/or an operational mode to the four slave BSMCs 100B-100E. The user of the system may initially configure the four slave BSMCs 100B-100E into the slave operational mode, and also configure the master BSMC 100A into the master operational mode. Thereafter, the user may simply provide operational mode and/or match list information to the BSMC 100A, and the slave controllers 100B-100E will self-configure based on the information published by the BSMC 100A.

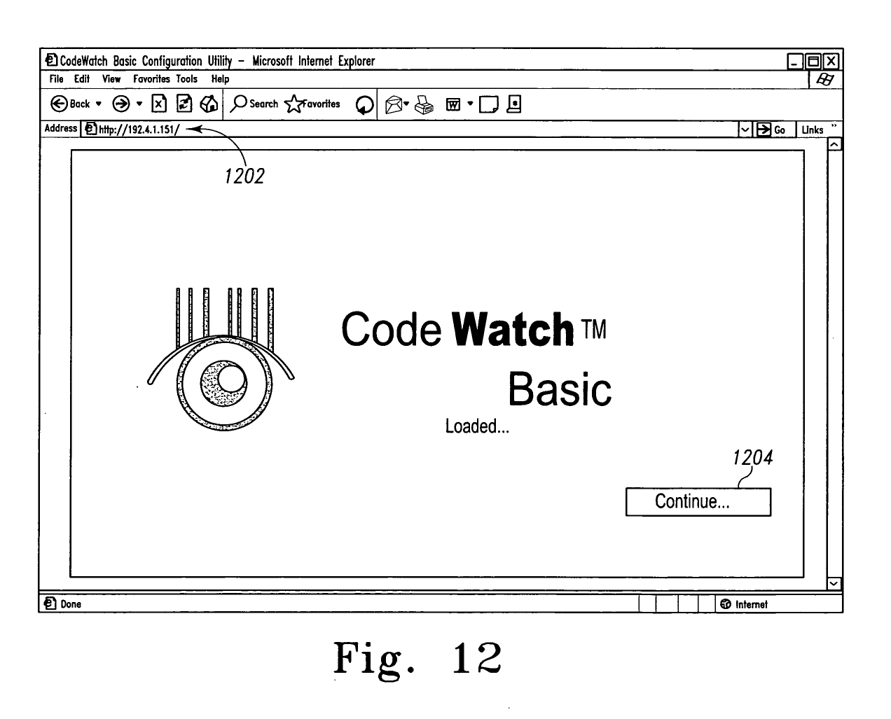

Turning to FIG. 12, an illustrative graphical user interface for the web browser 190 will now be described. Those of skill in the art will understand that there are a variety of ways in which the graphical user interface generated by the BSMC 100 may be implemented. The illustrative graphical user interface described herein is merely illustrative, and is not intended to limit the claimed invention in any way. Depending on the particular configuration of the BSMC 100, any slave controllers 100, and the scanner(s) 196 connected thereto, the type of information and the layout of the graphical user interface may change significantly. Nevertheless, the claimed invention is intended to cover all types of graphical user interfaces generated by BSMCs.

On the web page shown in FIG. 12, the user first enters a universal resource locator (URL) in the address bar 1202 of the web browser 190. This causes the web browser 190 to send an HTTP “Get” request to the BSMC 100 via the network 192. Upon receiving this request, the BSMC 100 may download an object to the web browser 190. For example, this object may be Java script, a Java applet, a Macromedia Flash object, or the like. Additionally, the BSMC 100 may utilize a more traditional dynamic web page server comprising a CGI-type interface and a web server. The BSMC 100 may store the object in the ROM memory 214 or in the RAM memory 212. Additionally, the BSMC may contain software in the ROM memory 214 or in the RAM memory 212 that allows for the dynamic generation of the based on the current configuration of the BSMC 100.

In the illustrative example disclosed herein, the BSMC 100 downloads a Macromedia Flash object to the web browser 190. After this object has been downloaded to the web browser 190, the web page shown in FIG. 12 is displayed indicating that the object has been loaded. After the object has been loaded, the user may select button continue 1204 to continue into the program. After the user selects the button continue 1204, the web page shown in FIG. 13 is displayed. In this web page, the user may enter his user name in text box 1302, and his password in text box 1304. Once the user has entered these authentication tokens, the user may select the login button 1306. Alternatively, in order to proceed directly to the main menu without reviewing the status screen, the user may select the main menu button 1308.

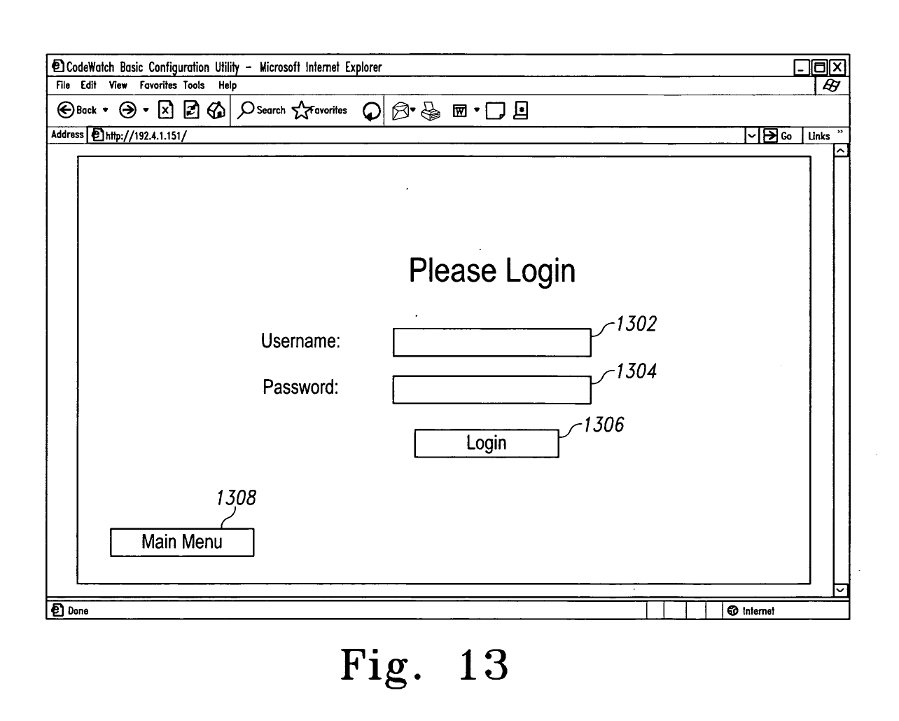

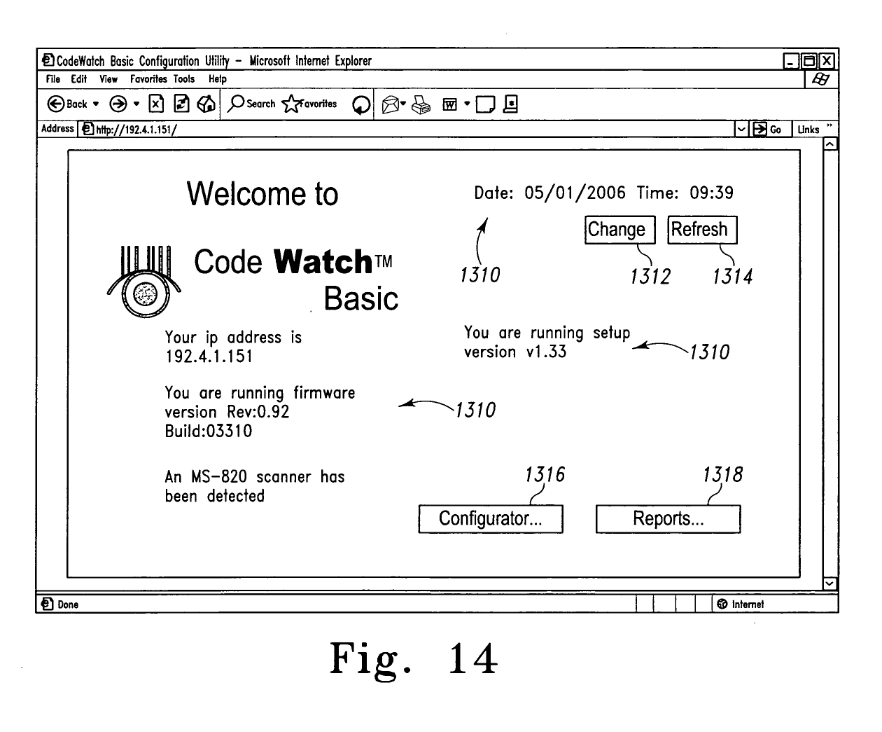

Turning to FIG. 14, after the user selects the login button 1306, the web browser displays the web page shown in FIG. 14. Status text 1310 indicates the IP address of the BSMC 100, the firmware version running on the BSMC 100, the type of scanner 196 that has been detected by the BSMC 100, and the version of the web browser object that is currently being executed by the web browser 190. Additionally, the date and time are shown on the web page. The user may select the change button 1312 in order to change the date and/or time, or select the refresh button 1314 in order to update the date and/or time display, as well as the other status text 1310. Additionally, the user has the option to either view reports by selecting reports button 1318, or to configure the BSMC 100 by selecting the configurator button 1316.

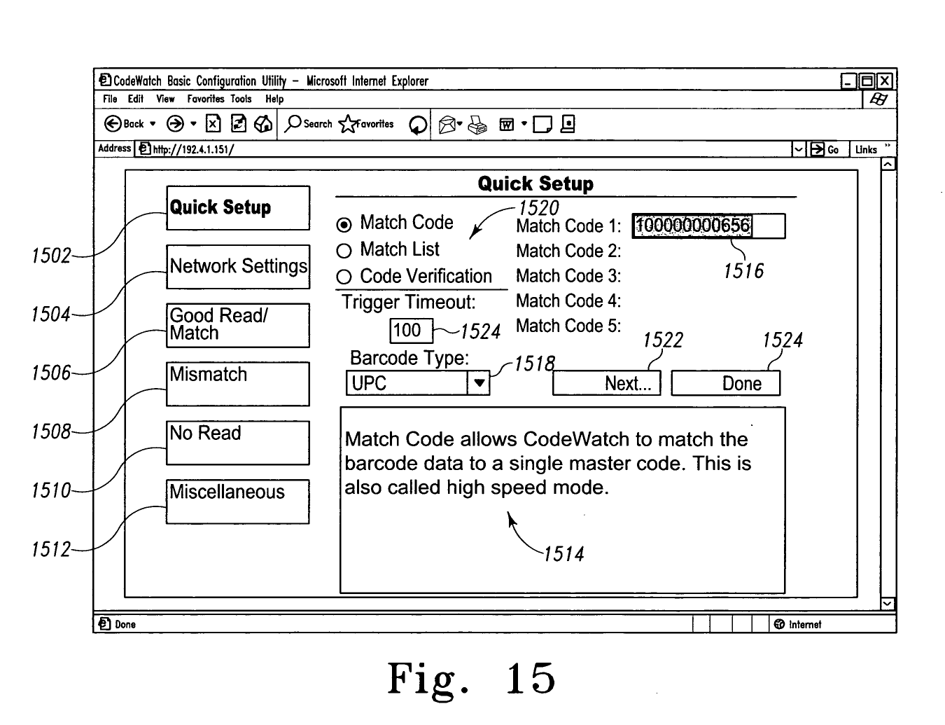

If the user selects the configurator button 1316, the web page shown in FIG. 15 is displayed by the web browser 190. The web page shown in FIG. 15 provides a graphical user interface for configuring the BSMC 100. For example, the user may select quick setup button 1502 in order to display the quick setup screen shown in FIG. 15. This quick setup screen allows the user to select one of three primary modes via the radio buttons 1520. In the first primary mode, the match code mode, a single code is entered into the match list. In this mode, the BSMC 100 compares each code read by the scanner 196 to this match code. The next primary mode of operation is the match list mode. In this mode of operation, the BSMC 100 compares each code read by the scanner 196 to the match codes in the match list. The next primary mode of operation is the code verification mode. The code verification mode is also described herein as “good/bad mode.” In the code verification mode, the BSMC 100 determines whether or not the scanner was able to read a valid code from an object during a trigger cycle.

Additionally, the user may set up the trigger time out in text box 1524. The trigger time out indicates the trigger cycle, or the amount of time after the trigger signal is received by which a read is expected. In other words, if the trigger signal is activated, and a valid read has not occurred by the end of the end of the trigger cycle, then the BSMC 100 will determine that the read was a bad read. In drop down menu 1518, the user may select the type of bar code being read. In this example, the user has selected the UPC type of bar code.

The user may individually enter the match codes into the match list in text box 1516. In this illustrative example, the match list consists of five match codes. Text box 1514 describes the currently selected operational mode at a high level. In the illustrative example shown in FIG. 15, a description of the match code mode is shown because the match code radio button 1520 is currently selected.

In addition to selecting the quick set-up button 1502, the user may also select from a variety of other setup options. For example, the user may adjust the network settings by selecting network settings button 1504. The user may select the good read and match parameters by selecting good read/match button 1506. The user may select the no read parameters for determining whether a read was valid by selecting no read button 1510. Additionally, the user may set other miscellaneous values by selecting button 1512. A given setup mode, such as the quick setup mode, may have additional screens, which may be accessed by selecting the next button 1522. Once the user has entered all required information into a given setup mode, the user may select the done button 1526.

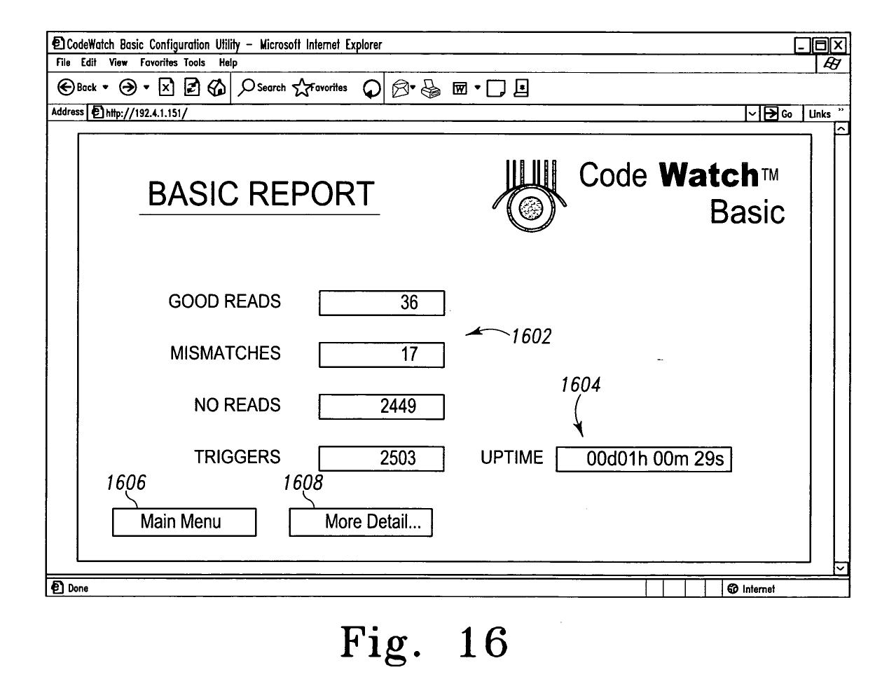

If on the web screen shown in FIG. 14, the user selected the reports button 1318, then the web page shown in FIG. 16 is displayed. FIG. 16 is the basic reporting screen, which shows basic reporting information in text boxes 1602. For example, the number of good reads, mismatches, no reads, and triggers is shown in the text boxes 1602. Additionally, the amount of time that the scanner has been operational is shown in text box 1604. If the user desires to see more detail, the user may select the more detail button 1608. If the user desires to return to the main menu, the user may select the main menu button 1606.

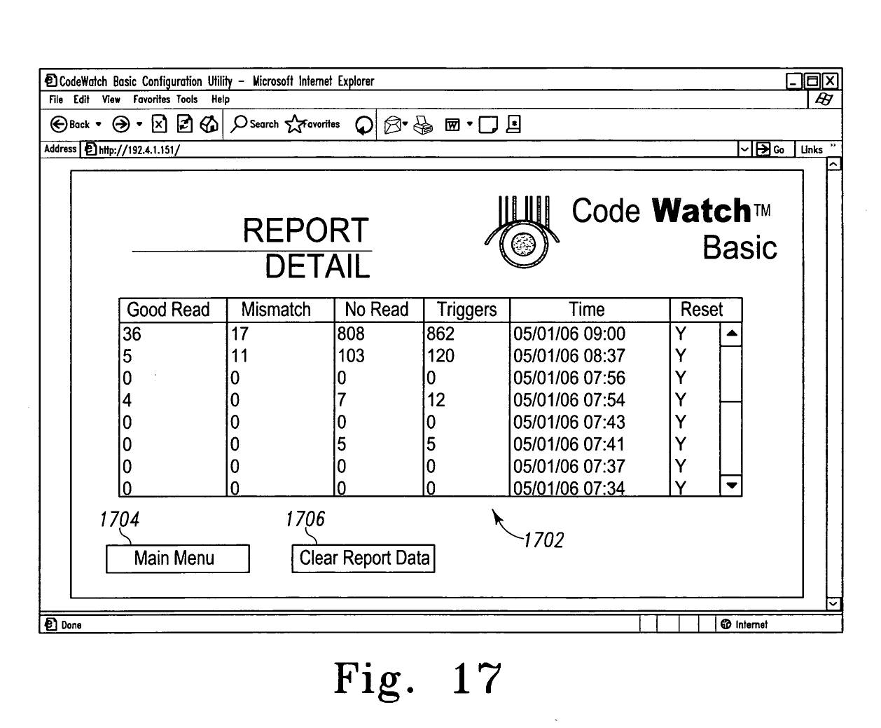

If the user selects the more detail button 1608, the report detail web page shown in FIG. 17 is displayed in the web browser 190. Table 1702 shows detailed information regarding the number of good reads, mismatches, no reads, and triggers at various times, as that information is reported by the BSMC 100. The user may clear the report data in Table 1702 by selecting clear report data button 1706. Additionally, the user may return to the main menu by selecting button 1704.

Although the disclosed apparatus, method and user interface have been described in detail with reference to certain preferred or illustrative embodiments, variations and modifications exist within the scope and spirit of the invention as described and as defined in the claims

What is claimed is:

1. A Barcode Symbology and/or Match Checker (“BSMC”) for use with a scanner for reading bar-code symbology, the BSMC comprising:
a processor;
a network port communicatively coupled to the processor; and
a scanner interface port communicatively coupled to the processor;
wherein the processor receives data from the scanner interface port and transmits messages based on the received data to the network port and wherein the processor is running a web server application including an automated object downloader for transporting a web component into a web browser of a user communicatively coupled to a network communicatively coupled to the network port.

2. The apparatus of claim 1, including memory maintained internally to the BSMC and communicatively coupled to the processor for storing the web server application and at least one master code for comparing to barcode symbology read by the scanner.

3. The apparatus of claim 2, wherein a user may obtain a status of a scanning process carried out by the scanner via the web browser.

4. The apparatus of claim 3, wherein the network port is an Ethernet port.

5. The apparatus of claim 4, wherein the Ethernet port provides for communication between the network and the processor.

6. The apparatus of claim 3, wherein the BSMC is configured to accept one or more master codes entered by a user via the web browser.

7. A scanning system comprising:
a network;
a web browser communicatively coupled to the network;
a scanner configured to read barcode symbology; and
a BSMC communicatively coupled to and controlling the scanner via a scanner interface port, the BSMC further including a processor and a network port communicatively coupled to the processor and the network, wherein the processor receives data from the scanner via the scanner interface port and transmits messages based on the received data to the network port and wherein the processor is running a web server application for communicating with the web browser via the network port.

8. The system of claim 7, wherein the BSMC further comprises memory maintained internally to the BSMC and communicatively coupled to the processor for storing the web server application and at least one master code for comparing to barcode symbology read by the scanner.

9. The system of claim 8, wherein a user may obtain a status of a scanning process carried out by the scanner via the web browser.

10. The system of claim 9, wherein the web server application includes an automated object downloader for transporting a web component into the web browser.

11. The system of claim 10, wherein the network port is an Ethernet port.

12. The system of claim 11, wherein the Ethernet port provides for communication between the network and the processor.

13. The system of claim 11, wherein the web browser has HTTP compliant web browser software running thereon.

14. The apparatus of claim 10, wherein the BSMC is configured to accept one or more master codes entered by a user via the web browser.

15. A scanning system comprising:
a network;
a network browser coupled to the network;
a first scanner;
a first BSMC communicatively coupled to and controlling the first scanner via a first scanner interface port, the first BSMC further including a first processor and a first network port coupled to the first processor, the first scanner being configured to operate in a master operational mode and wherein the first processor receives data from the first scanner via the first scanner interface port, and transmits messages based on the received data to the first network port;
a second scanner;
a second BSMC communicatively coupled to and controlling the second scanner via a second scanner interface port, the second BSMC further including a second processor and a second network port coupled to the second processor, the second BSMC being configured to operate in a slave operational mode, and wherein the second processor receives data from the second scanner via the second scanner interface port, transmits messages based on the received data to the second network port and receives instructions from the first BSMC via the second network port.

16. The system of claim 15, wherein the first BSMC further comprises a web server maintained internally to the first BSMC.

17. The apparatus of claim 16, wherein a user may obtain a status of scanning processes carried out by the first and second scanners via the web browser communicating over the network with the first BSMC via the first network port.

18. The system of claim 17, wherein the web browser allows a user to configure the first BSMC with a match list and an operational mode.

19. The system of claim 18, wherein the first BSMC publishes the match list and the operational mode to the second BSMC.

20. The system of claim 19, wherein the second BSMC self-configures based on the information published by the first BSMC.
